(19) United States
(12) Patent Application Publication
(10) Pub. No.: US 2006/0031105 A1
(43) Pub. Date: Feb. 9, 2006

(54) Method and system of managing an online reservation system for a business center

(76) Inventors: Clement Lee, San Francisco, CA (US); Edwin Lam, El Cerrito, CA (US); Choi Lawrence, El Cerrito, CA (US)

Correspondence Address: Sean M. Fitzgerald, 3182 Campus Drive #342, San Mateo, CA, 94403-3123, US

(21) Appl. No.: 10/894,352

(22) Filed: Jul. 18, 2004

(51) Int. Cl. G06Q 10/00

(52) U.S. Cl. 705/5; 705/26

(57) ABSTRACT

The present invention provides a method and system for presenting and booking office space, conference rooms and other resources of a business center. Visitors to a business center portal may view business center properties, check the availability of business center facilities resources such as offices or conference rooms, and book the facilities that meet their needs. The present invention allows automatic updating of business center facilities resources and synchronization between a business center booking system and the management systems of business centers. Business centers that use the booking system to manage inventory of their business center can provide real time availability of their available resources through the business center portal.

### BACKGROUND

1. Field of the Invention

The field of the invention relates generally to systems for maintaining and managing customer relationships. More particularly, the present invention relates to the field of managing a business center.

2. Related Background

Business centers have grown increasingly popular as the demand for temporary office space, meeting rooms and conference facilities has grown. Most business centers provide offices, conference rooms and other space on a rental basis by the hour, day, week, month, or longer. Often, these rentals are sporadic, where clients rent space in different locations or at different times on an as-need basis. This makes managing the use and availability of space a complex and challenging task, with customers requesting space on short notice and often changing or canceling reservations.

The need for efficient management of such space is heightened by the economics of the business center business. Business centers have high fixed costs in real estate, furniture, and equipment (such as projectors or video conference equipment). Profitability is highly dependent on the ability to maximize utilization of the business centers facilities.

Currently, business centers utilize brokers and online referral sites to generate business. Current referrals sites provide a general description of the facilities, such as the size, quality, and amenities. A potential client can enter their information and the referral site will forward the potential client's contact information to the business centers or business center brokers who contact the potential client. These referral systems do not provide real time availability information, as conventional referral systems are not integrated with the management systems used by business centers. Other than a referral, these systems provide little in the way of efficiencies or automation, leaving much of the process of booking space and billing clients to traditional manual methods.

Finding, comparing and booking business center facilities can be a time consuming and difficult process for the business center consumer. Using referral sites often leads to multiple brokers contacting the consumer, potentially after the consumer has booked with another broker. As conventional systems do not include comprehensive information from multiple business centers, and do not provide real time inventory and availability, consumers are unable to quickly and easily compare the available offices or other facilities resources from a wide range of business centers to find the business center that best meets their needs.

An example of current business center sites is given by Regus Business Centers (www.regus.com). Visitors are allowed to enter their contact information and some information specifying what their interests are, and a broker will contact them by phone or email.

Accordingly, a need exists to provide an efficient and automated booking and payment system.

### BRIEF DESCRIPTION OF THE FIGURES

FIG. 1 is a generalized block diagram of a computer system that may be used to implement the present invention.

FIG. 2 is a generalized block diagram of a computer system that may be used to implement the business center portal.

FIG. 3 is a generalized block diagram of a server computer that may be used to implement the present invention.

FIG. 4 is a generalized block diagram of a business center portal page displaying available business center facilities, according to one embodiment of the invention.

FIG. 5A is a generalized block diagram of a location selection page, according to one embodiment of the invention.

FIG. 5B is a generalized block diagram of an business center properties page, according to one embodiment of the invention.

FIG. 6 is a generalized block diagram of an office date selection page, according to one embodiment of the invention.

FIG. 7 is a generalized block diagram of a conference room date and time-slot selection page, according to one embodiment of the invention.

FIG. 8 is a generalized block diagram of an available property listing page, according to one embodiment of the invention.

FIG. 9 is a generalized block diagram of the selection page, according to one embodiment of the invention.

FIG. 10 is a generalized flow diagram of the process of updating the inventory database, according to one embodiment of the present invention.

FIG. 11 is a generalized flow diagram of the process of selecting a business center facilities resource, according to one embodiment of the present invention.

### SUMMARY

The present invention provides for a computer based system and method for presenting, searching and reserving business center facilities. A potential customer can locate available business center facilities, view available offices, conference rooms or other facilities currently available, select according to price, location, quality, amenities, or other criteria, and reserve the available facility. The reserved business center resource is then removed from the available inventory for future inquiries by potential customers.

In one aspect of the present invention, the business center portal updates the business centers servers to reflect the reservation of a business center resource. Additionally, the business center portal may determine whether changes have been made in the available inventory of the business center server, and update the inventory database of the business center portal to reflect changes in the available inventory.

### DETAILED DESCRIPTION

The present invention is described in the context of a specific embodiment. This is done to facilitate the understanding of the features and principles of the present invention and the present invention is not limited to this embodiment. In particular, the present invention is described in the context of a web site for displaying and booking business center facilities.

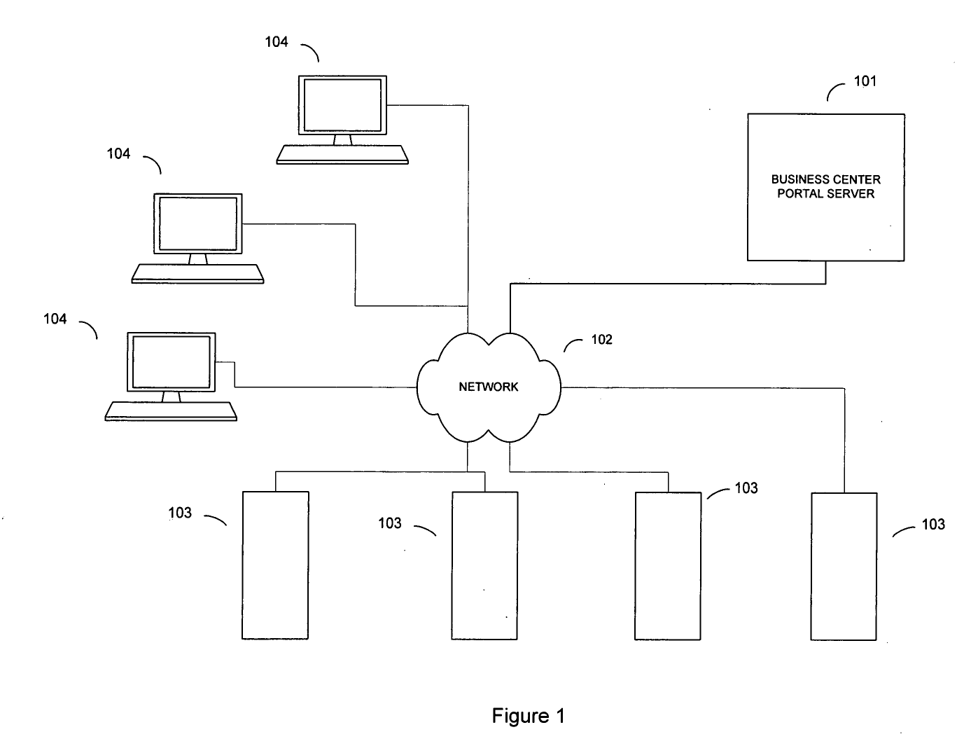

FIG. 1 is a block diagram of a computer system 100 that may be used to implement embodiments of the present invention. A business center portal server 101 is connected to a communications network 102. Business center servers 103 are connected to the business center portal server through communications network 102. End-user communication devices 104 are connected to the business center portal server through the communications network 102. The business center servers are the servers used to manage the inventory and/or sales of a given business center. Typically, each business center maintains its own inventory of available facilities resources which is available on the business center server.

In the presently preferred embodiment, the end-user communications device is a personal computer. Additionally, in the presently preferred embodiment the communications network is the Internet. Connection to the Internet could be by any form of Internet connection, including broadband and wireless connection. Alternatively, a private network or direct link could be established between the business center portal server and the business center servers. Alternatively, the end user communications device could be a mobile phone (including web enabled mobile phones or mobile phones with text messaging capabilities), standard telephone, or any other device capable of receiving text or voice messages.

The business center portal server could be implemented on one single server or on multiple servers. As used in the present application, the term server may refer to a physical computer or to software performing the functions of a server.

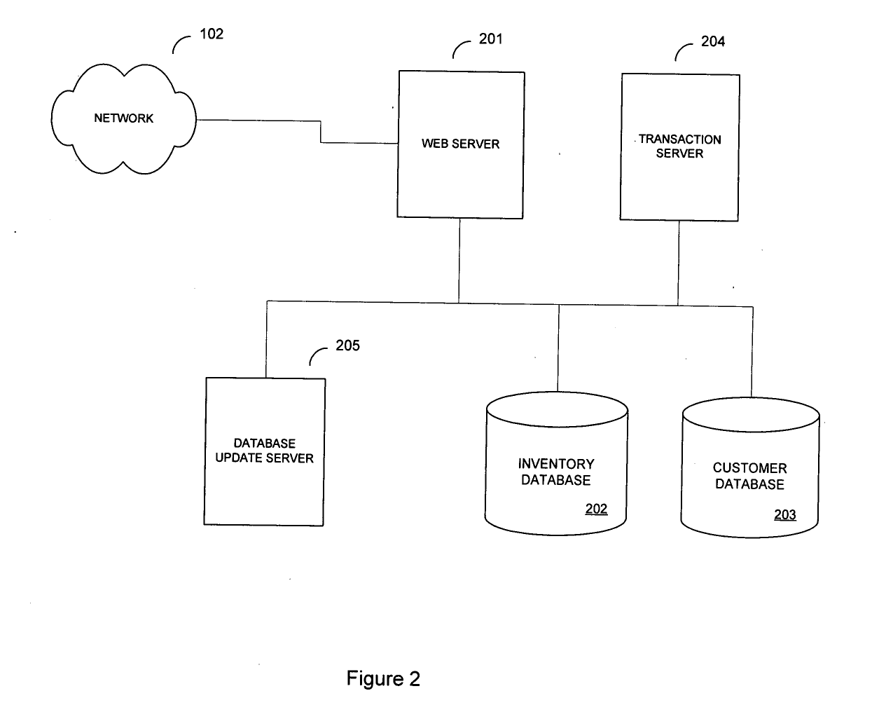

FIG. 2 is a generalized block diagram of the business center portal server shown in FIG. 1. A web server 201 provides web pages describing the business center facilities and services available through a communication network 102. The web server is connected to a business center inventory database 202, a customer database 203, a transaction server 204 and a database update server 205. The transaction server 203 allows potential customers to reserve facilities and order services. The customer database server 204 stores information relating to customers and the services and facilities they have requested or purchased. The database update server 205 updates the business center inventory database from the business center servers and provides update information to the business center servers.

While the presently preferred embodiment utilizes an inventory database as a separate database from the customer database, alternate embodiments could have utilize one database for both inventory and customer information. Additionally, the information stored within any single database of the presently preferred embodiment could be distributed among several databases in alternative embodiments.

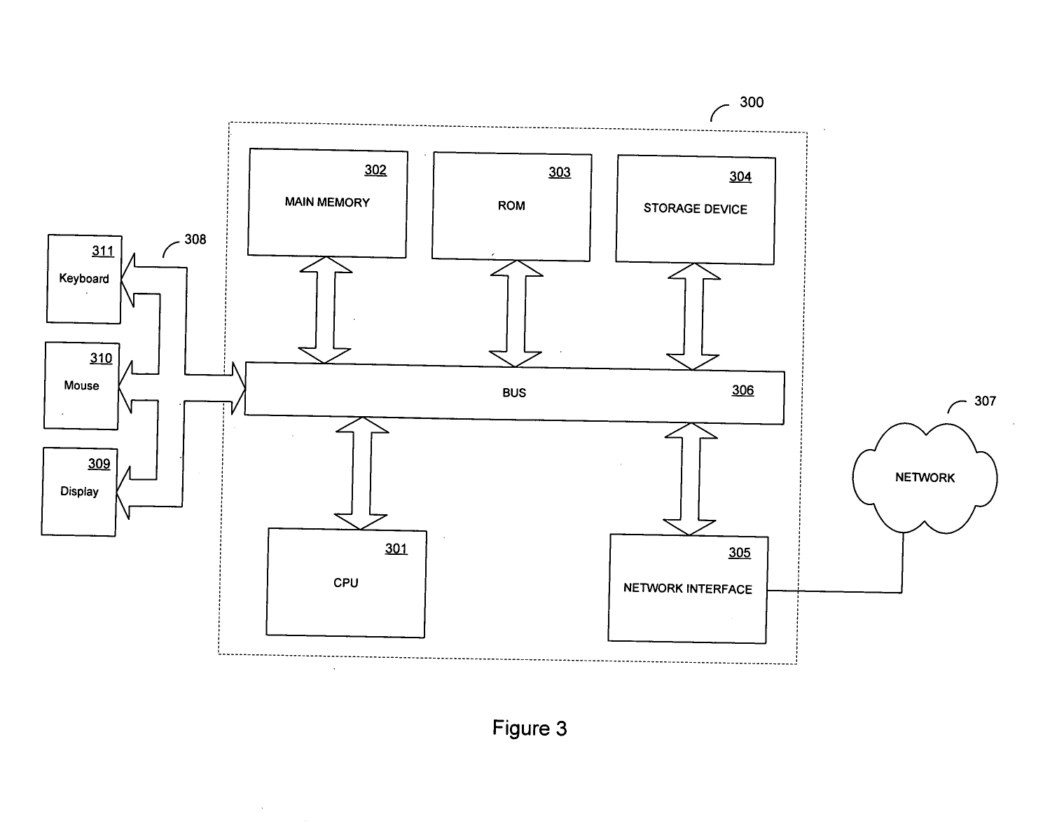

FIG. 3 is a generalized block diagram of a business center portal server computer 300 including a central processing unit (CPU) 301, main memory (typically RAM) 302, read-only memory (ROM) 303, a storage device (typically a hard drive) 304, and a network device (typically a network interface card, a.k.a. NIC) 305. The network device connects to a communications network 307. The server includes a bus 306 or other communication mechanism for communicating information between the CPU 301 coupled with bus 306. The CPU 301 is used for processing instructions and data. The main memory 302, ROM 303 and storage device 304 are coupled to bus 306 and store information and instructions to be executed by processor 301. Main memory 302 also may be used for storing temporary variables or other intermediate information during execution of instructions to be executed by processor 301.

Server 300 may be coupled via bus 308 to a display 309, such as a cathode ray tube (CRT) or flat panel monitor, for displaying information to a computer user. An input device 310, such as a keyboard, is coupled to bus 308 for entering information and instructions to the server 300. Additionally, a user input device 311 such as a mouse, a trackball, or cursor direction keys for communicating direction information and command selections to the processor 301 and for controlling cursor movement on the display 309 may be used with the server 300.

The server 300 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 301 for execution. Such a medium may take many forms including, but not limited to, non-volatile media, volatile media, and transmission media. Examples of non-volatile media include, for example, optical or magnetic disks, such as storage device 304. Examples of volatile media include dynamic memory, such as main memory 302. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 306 and 308. Transmission media can also take the form of acoustic, electromagnetic or light waves, such as those generated during radio-wave and infra-red data communications.

The business center server and end user communication device are similar in general architecture to the business center portal server.

Presenting and Selecting Business Center Inventory

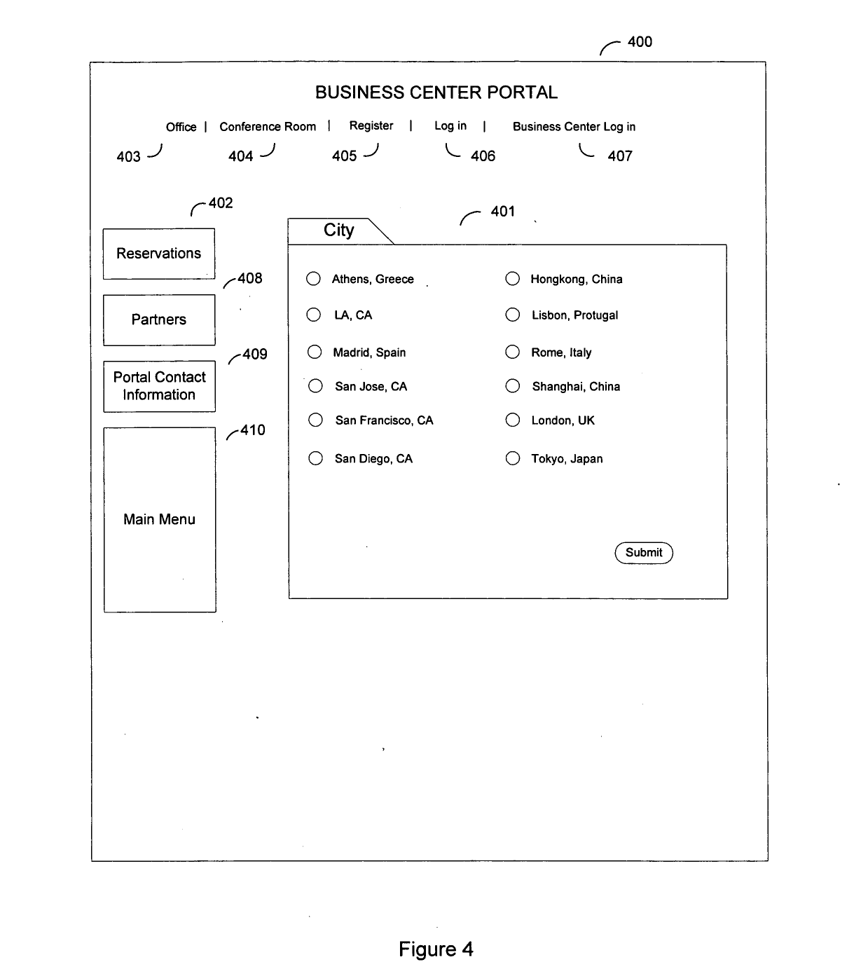

The present invention provides a web accessible portal for visitors to search for, view, reserve and book business center facilities resources, such as offices and conference rooms. FIGS. 4-9 illustrate the business center facilities resource selection and booking aspect of the present invention. In the presently preferred embodiment, the pages shown in these figures are accessible to a potential customer over the Internet using a web browser.

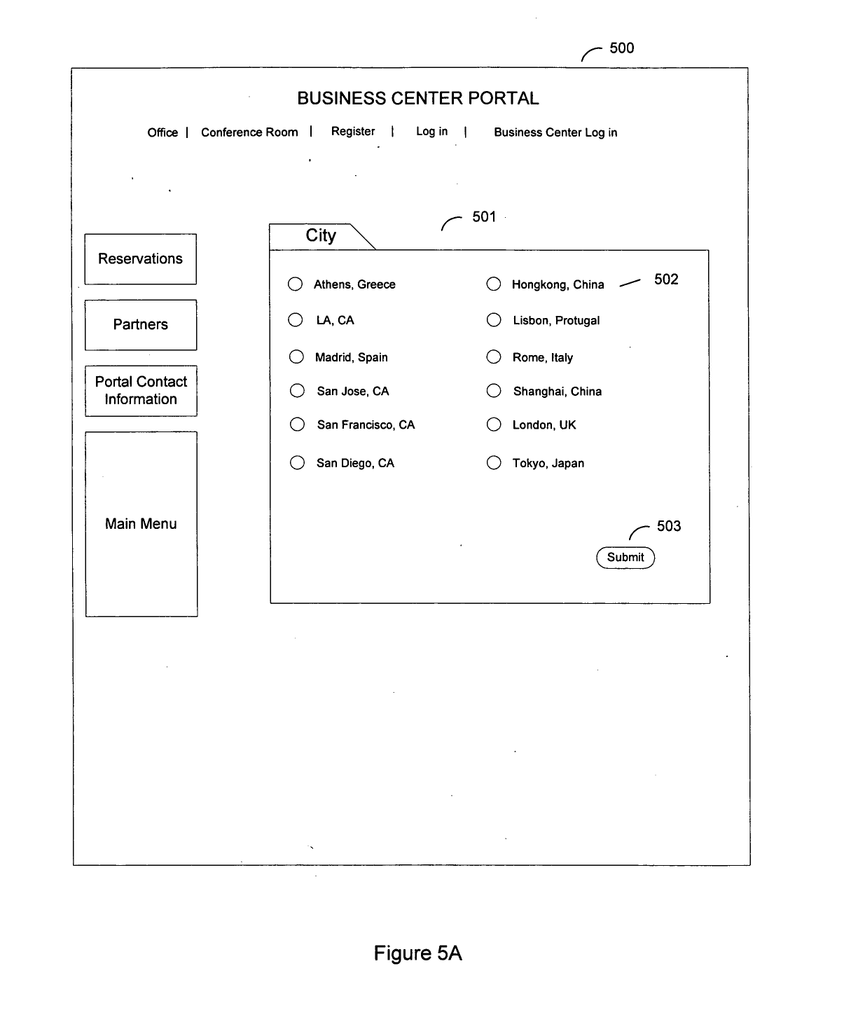

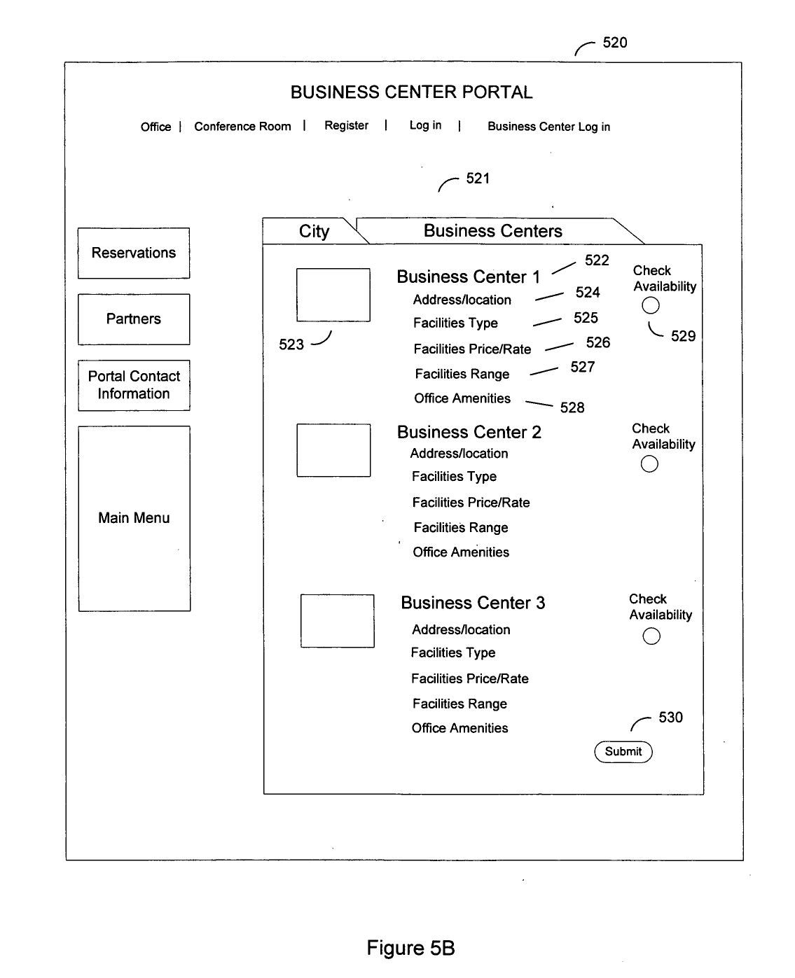

FIG. 4 is a generalized block diagram of a business center portal page 400. A location selector 401 allows visitors to move to a specific region or location. The location selector is described in connection with FIG. 5A. A reservations link 402 allows a visitor to connect to a reservations page which display's the visitor's current reservations. An office link 403 allows a visitor to view an office properties page 520 shown in FIG. 5B. While location indicators 502 are text indicators, alternate embodiments of the present invention may use graphical indicators depicting a symbol or map. A conference link 404 allows a visitor to view a conference facilities page 520 shown in FIG. 5B. A log in link 405 takes a visitor to a sign in page where the visitor can enter their username and password to allow them to view specific information particular to that visitor. A register link 406 takes a visitor to a registration page where the visitor can create a personal account with a username and password. A business center log in link 407 connects a visitor with business center management page.

Additionally, page 400 also includes a partner link 408 which connects to partners of the business center portal, a contact link 409 which takes a visitor to a page displaying contact information for the business center portal, and a menu 410 which has links to several pages within the portal. As described, business center portal page 400 has several links common to several pages of the present invention.

FIG. 5A is a generalized block diagram of the location selection page 500. A location selector 501 allows visitors to move to a specific region or location. Locations where business center facilities are available are presented at the location indicators 502. In the presently preferred embodiment the locations are cities where there is a business center. Alternatively, the location indicators may identify countries, states or provinces, regions, neighborhoods or any other geographic location. In the presently preferred embodiment, by selecting a location the visitor is taken to the office properties page 520 shown in FIG. 5B. Optionally, once the visitor has made their sections of dates and number of persons the visitor may hit enter or click the submit button 503 to be taken to the office properties page 520.

FIG. 5B is a generalized block diagram of the office properties page 520. The properties according to a given criteria, for example in a specific region as selected on page 500 described above, are shown in a business center property list 521. Property identifier fields 522 identify the business centers. The business centers located on the page could include all the business centers available through the portal, or a subset of the business centers available. The subset of available business centers displayed on the properties page could be based on geographic area, type of facility, services available, quality level, price level, length of time available, minimum contract length, ownership or affiliation, or other aspects of the property or service provided by the business center.

In the presently preferred embodiment, the business center properties page also includes property image 523, property location 524, facilities type 525, facilities rate (or price) 526, and facilities amenities 527. The property location indicator can either be a textual indicator, indicating a city, town, region, neighborhood, district or street address, or it could be graphical, representing location information in a map or symbol form. The facilities type indicator provides information on the type of building, such as an office tower or high rise, executive office park, office park, strip mall, mixed live/work, or other type of facility. A visitor to the business center portal may check on the availability of a particular property by selecting the Check. Availability button 529, which will take the visitor to the date selection page 600 described below.

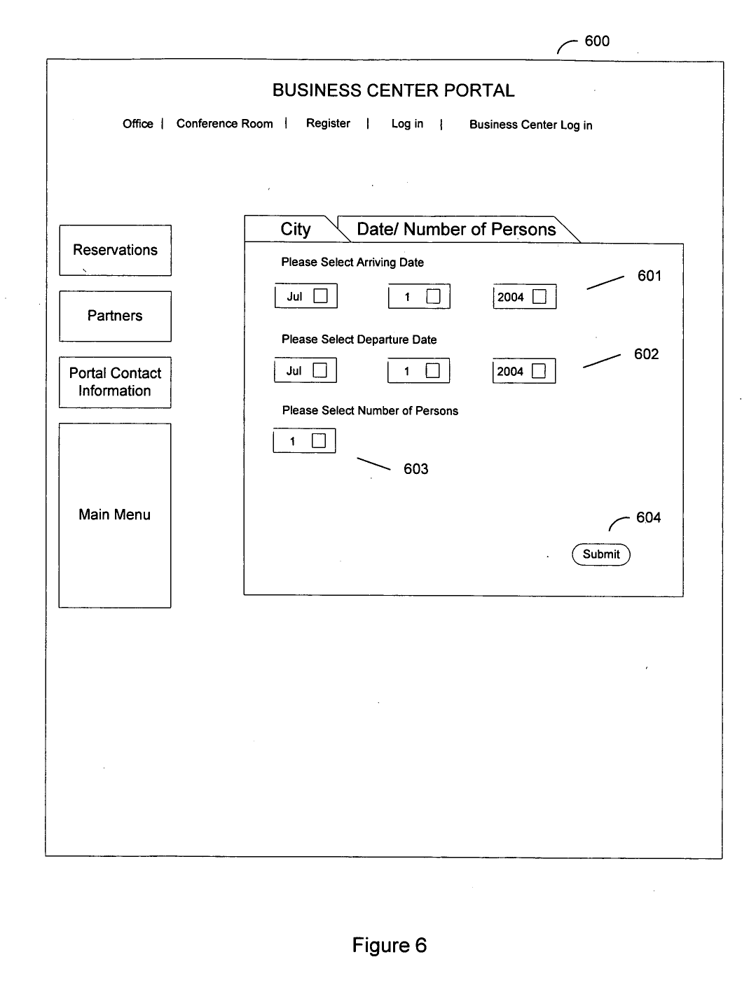

FIG. 6 is a generalized block diagram of an office date selection page 600. An arriving date selector 601 allows visitors to select the date they would first need an office at a business center. A departure date selector 602 allows visitors to select the date they would last such an office. The arriving date selector and departure date selector are in the form of a month, day, day year selector. Additionally, the date selector may include the arriving time and ending time for the visitor. Alternative designations could be sued such as a calendar selector, where the visitor selects a date from a calendar, or any other form of representing the date or time. In the presently preferred embodiment the date selection page 600 also includes a number of persons selector 603 where the visitor may specify the number of people who would need offices a the business center. Once the visitor has made their sections of dates and number of persons the visitor may hit enter or click the submit button 604.

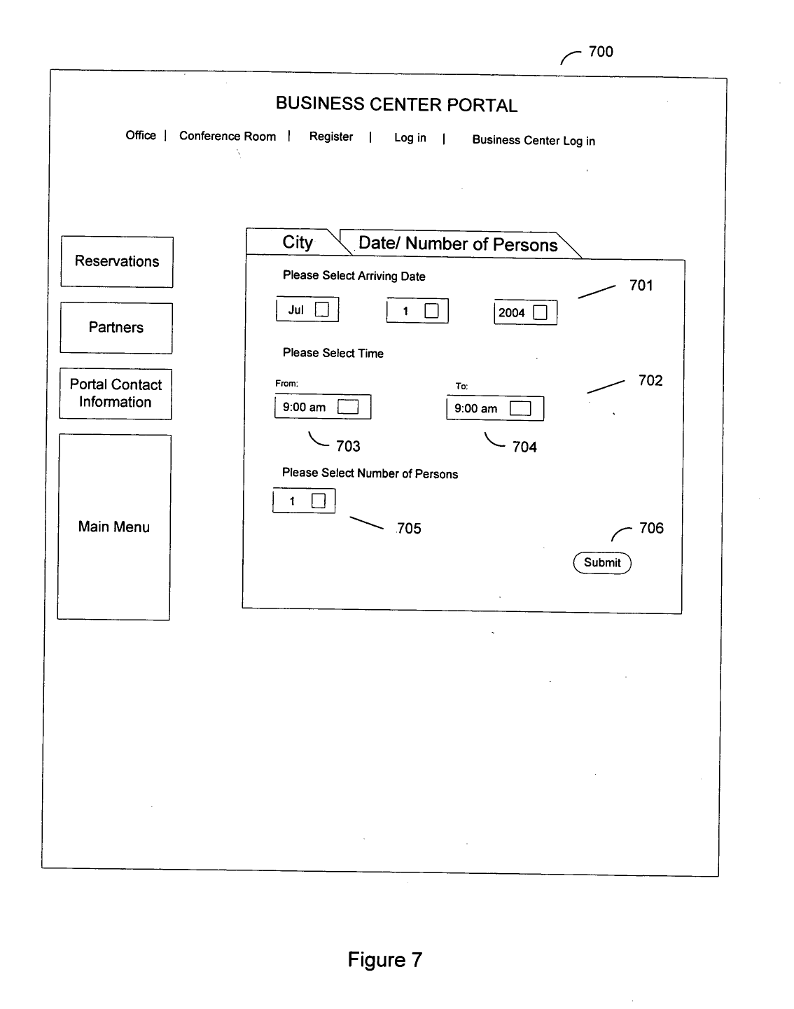

FIG. 7 is a generalized block diagram of a conference room date and time-slot selection page 700. A date selector 701 allows visitors to select the date they would need a conference room at a business center. A time slot selector 702 allows visitors to select the time-slot they would need a conference room. The time-slot selector 702 includes a start time selector 703 where a visitor may specify the start time for the conference room reservation. The time-slot selector 702 also includes a start time selector 704 where a visitor may specify the end time for the conference room reservation. In the presently preferred embodiment the conference room date selection page 700 also includes a number of persons selector 705 where the visitor may specify the number of people the conference room would need to accomodate. Once the visitor has made their sections of dates and number of persons the visitor may hit enter or click the submit button 706.

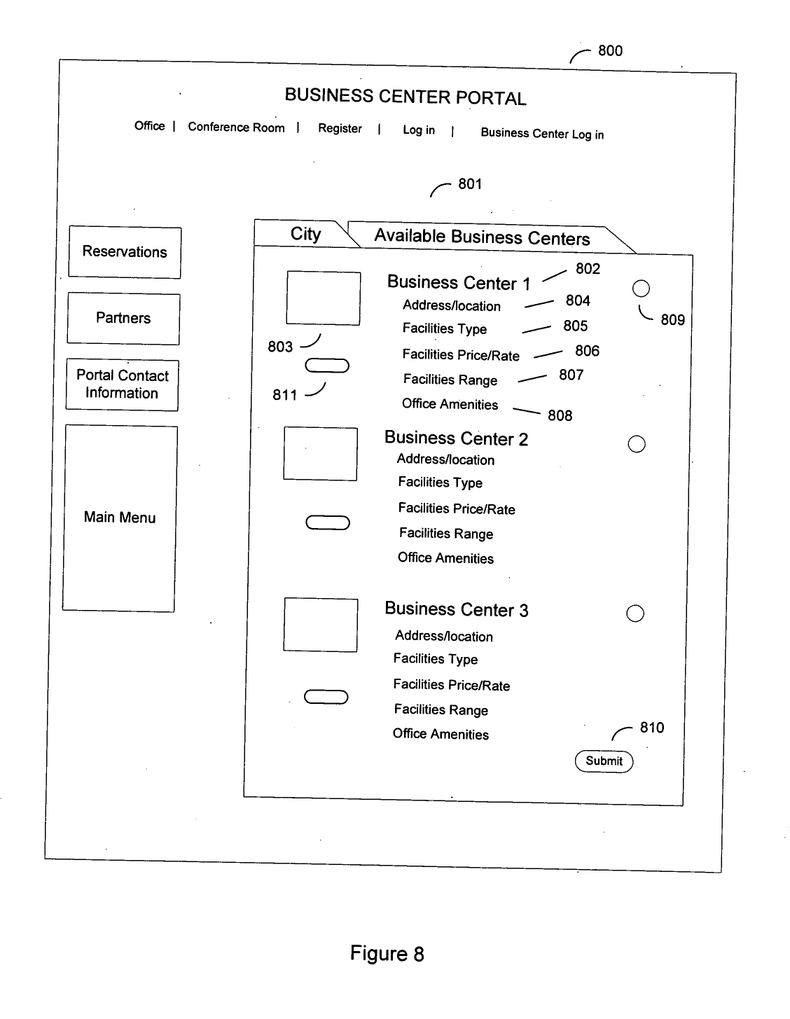

Once the date and time-slot selection query is entered from either the office date selection page 600 or conference room date and time-slot selection page 700 the business center portal system returns a list of available properties as shown in FIG. 8.

FIG. 8 is a generalized block diagram of an available property listing page 800. The property listing page 800 includes a list of properties returned from the search for available properties. In the presently preferred embodiment, the properties returned meet all of the criteria specified in the prior selection page. Alternatively, the returned results may meet a subset of the specified criteria, or may represent a closest relevant fit to the specified criteria.

The visitor may view the properties returned as well as compare and contrast the available offices or conference rooms. In the presently preferred embodiment, the properties returned are listed and displayed with the property name indicator 802, property image 803, property location 804, facilities type 805, facilities rate (or price) 806, facilities range 807, facilities amenities 808, and business center rating indicator 811. The property location indicator can either be a textual indicator, indicating a city, town, region, neighborhood, district or street address, or it could be graphical, representing location information in a map or symbol form. The facilities type indicator provides information on the type of building, such as an office tower or high rise, executive office park, office park, strip mall, mixed live/work, or other type of facility.

When a business center has more than one type of facilities resource the property listing page may include indicators 807 for the range of facilities resource types. For example, some business centers offer premium executive offices, standard offices, junior offices, and office suits within the same facility. As another example of the range of facilities resources, some business centers offer small conference rooms, large conference rooms, meeting rooms, or other types of meeting facilities. The facilities range indicator may specify the different types of facilities resources available.

The amenities indicator indicates the type of amenities or services available at the business center. Examples of amenities and services include phone answering services, package handling services, secretarial or word processing services, video conference services, or any other type of service or amenity offered by business centers.

The business center rating indicator 811 provides a quality rating of the business center. For example, some facilities are rated according to stars, such as three starts or four stars, based upon the quality of the facility.

Once the visitor decides which business center they would like to rent an office (or conference room) from the visitor may select that business center and be taken to the office selection page 900.

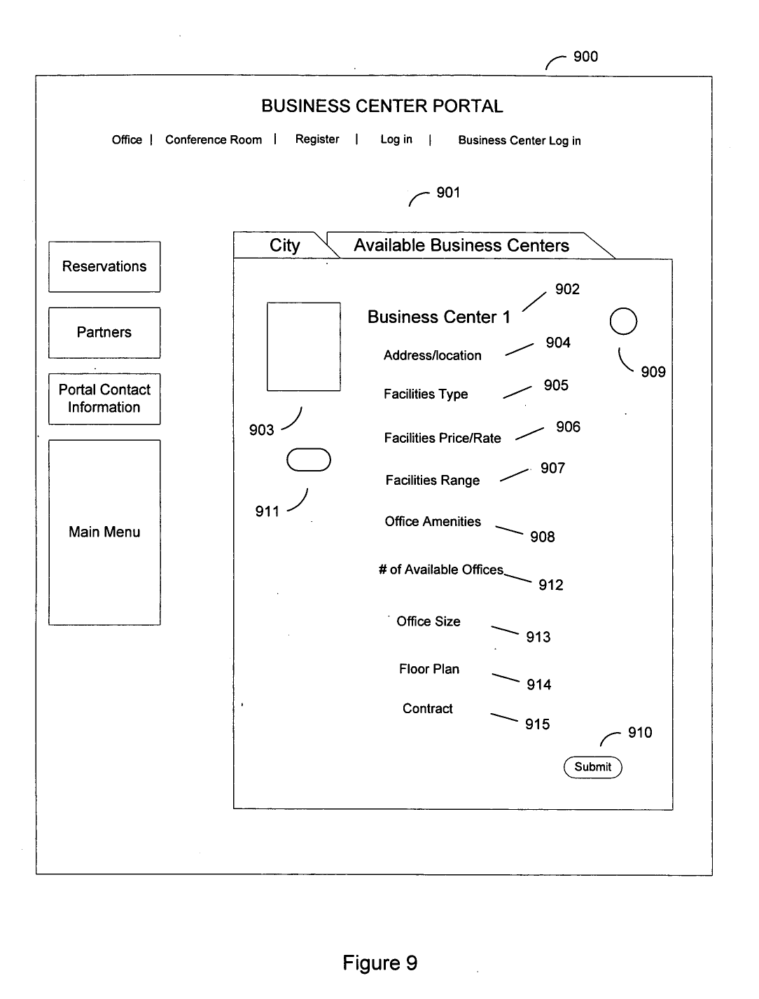

FIG. 9 is a generalized block diagram of the selection page 900. The selection page 900 gives the visitor additional details of the business center and office or conference room selected at the property listing page 800 shown above.

In addition to the information shown on page 900, such as the property name indicator 902, property image 903, property location 904, facilities type 905, facilities rate (or price) 906, facilities amenities 907, and business center rating indicator 911, the selection page 900 includes the number of available offices 912, the size of the office (or size range of the different types of offices) 913, the floor plan 914, and the types of available contracts 915. The types of available contracts 915 may include term contracts, such as hourly, daily or monthly, contract minimum commitments, for example 3 hour minimum for an hourly contract, deposit requirements, or other aspects or terms of the contract to book a business center facilities resource.

The visitor may book the business center facilities resource by clicking on the booking button 910.

Updating Business Center Portal Inventory

The present invention provides the access to available inventory in “real time” by synchronizing the inventory of the portal and the business centers. Business centers have the option of manually entering their inventory to the business center portal, or they may have the business center portal obtain inventory updates from the business center server.

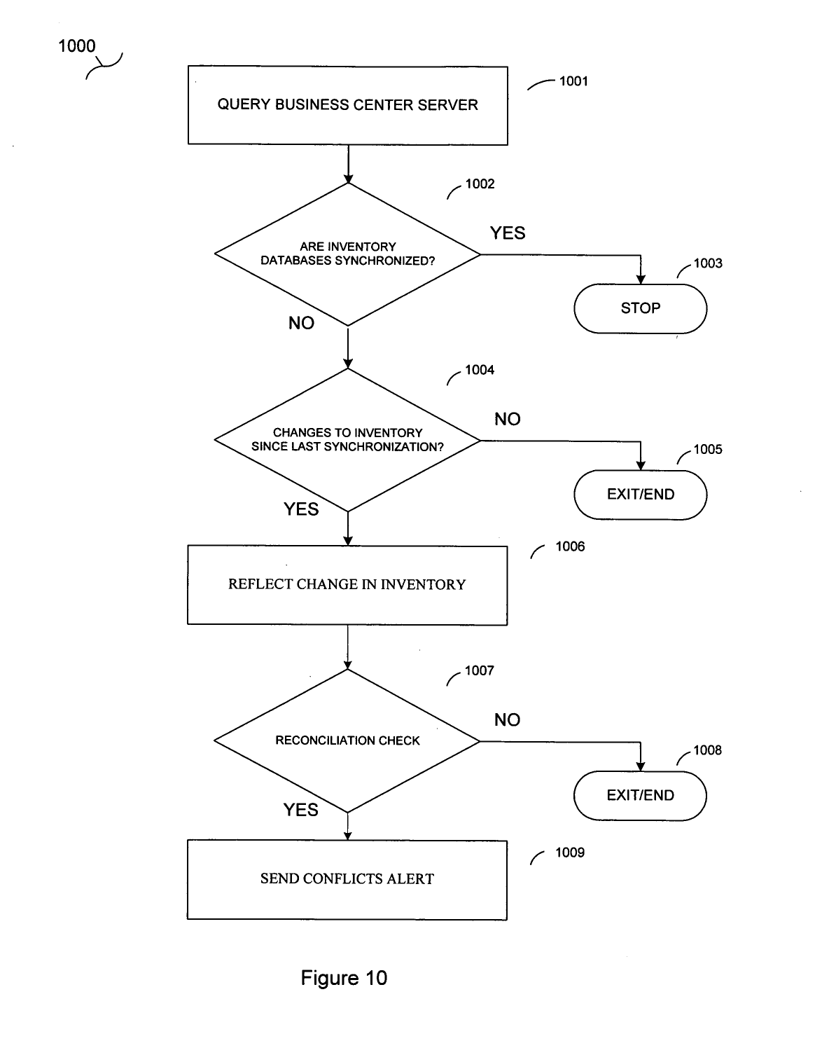

FIG. 10 is a generalized flow diagram of the process 1000 of updating the inventory database. According to the presently preferred embodiment, the business center portal queries the business center servers at step 1001 to determine whether the inventory in the business center's server is synchronized with the inventory of the business center portal, contained in the inventory database. At step 1002 the business center portal determines whether the two inventories are synchronized. If at step 1002 the system determines they are synchronized, then process 1000 proceeds to step 1003 and the synchronization ends. If at step 1002 the system determines the inventories are not synchronized, then the system proceeds with synchronization and advances to step 1004.

At step 1004 the system compares the two inventories to determine if the business center has added or removed inventory since the last synchronization. If at step 1004 the system determines the business center bas not changed its inventory or its availability, and that the business center portal has not changed the availability of the business center's inventory, the system proceeds to step 1005 and the synchronization process is stopped.

If at step 1004 the system determines the business center has added or removed inventory since the last synchronization the system proceeds to step 1006 where the changes in the business centers inventory is reflected in the inventory database of the business center portal. If the business center removed inventory, for example when the business center booked an office or a conference room, at step 1006 the system will remove these booked facilities resources as available from the inventory database of the business center portal. If the business center has added inventory, for example when a booking is cancelled or additional facilities are added during an expansion, then at step 1005 the system will add these facilities resources as available in the inventory database of the business center portal.

If at step 1004 the system determines the business center portal has added or removed inventory since the last synchronization the system proceeds to step 1006 where the changes in the business center portal's inventory is reflected in the business center server. If the business center portal removed inventory, for example when the business center portal booked an office or a conference room, at step 1006 the system will remove these booked facilities resources as available from the business center server. If the business center portal has added inventory, for example when a booking is cancelled or a tenant moves out early, then at step 1006 the system will add these facilities resources as available in the business center server.

After step 1006 the system proceeds to step 1007 where a reconciliation check is performed. Depending upon the frequency of synchronizations between the business center portal and the business center server, there exists the possibility that the business center portal and business center may make conflicting changes to the availability of a facilities resource, for example when the business center and portal both book the same office for a given day. At step 1007 the system checks for such conflicts and in the event of a conflict sends a conflicts message at step 1009 to the management of the portal and the effected business center indicating the details of the conflict. If no conflict is detected at step 1007 the system proceeds to step 1008 where the synchronization process ends.

While the current embodiment performs the conflicts check at the end of the synchronization process, alternate embodiments could perform the check before the two inventories are synchronized.

An alternate embodiment of the present invention allows business center management to use the portal as their own inventory management system. In this embodiment the business center management make direct changes to the business center portal inventory database. For example, when business center management book a facility, as is done with brokers, the management (or the broker) may log in to the business center portal and enter the booking, thereby removing the facilities resource from the list of available resources for the given time period.

Selecting and Booking Business Center Inventory

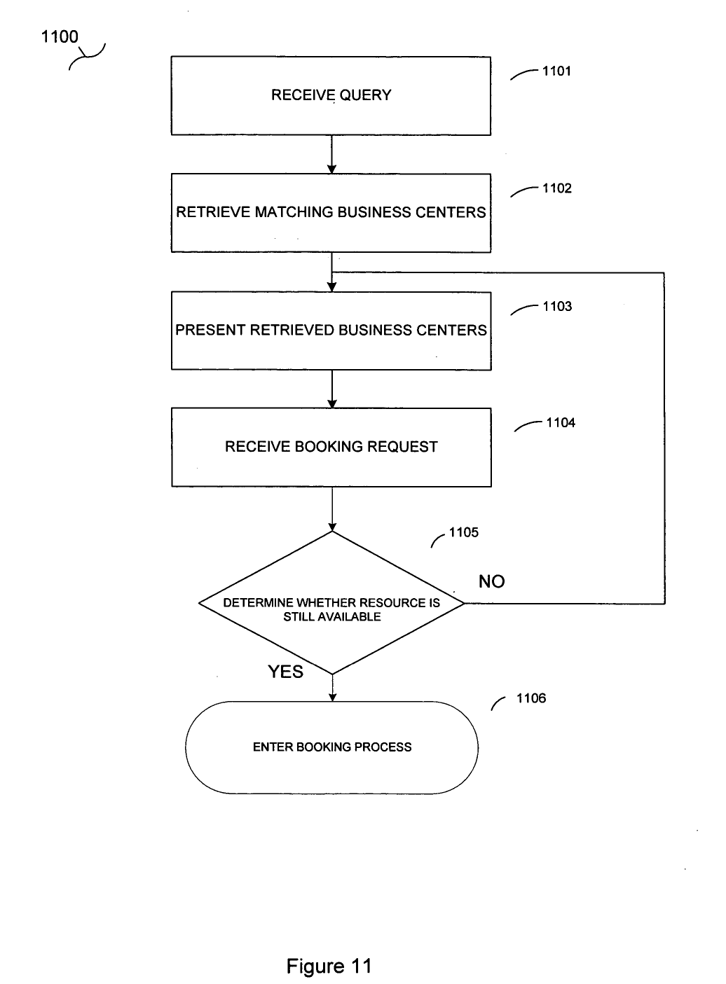

FIG. 11 is a generalized flow diagram of the process 1100 of selecting and booking a business center facilities resource using the business center portal described in connection with FIGS. 4 though 9. At step 1101 the system receives a query from an end user communication device. The query may specify the geographic area, the type of facility, as well as particulars relating to time, price or other aspects of business centers. At step 1102 the system retrieves the available business center facilities resources matching the query parameters from the inventory database of the business center portal. At step 1103 the system presents the results retrieved form the inventory database. In the presently preferred embodiment, the results are presenting by sending a web page to the end user communication device. The potential consumer may do additional searching, submitting additional queries, may ask for more information on a particular business center or business center facilities resource. The present invention will receive and respond to such queries as described in connection with steps 1101 through 1103. Once they decide to book a resource the customer clicks a book button which sends a book request to the business center portal. At step 1104 the business center portal receives a booking request. At step 1105 the system checks that the resource has not already become unavailable while the consumer was viewing search results. If at step 1105 the system determines the resource is no longer available the system presents an update to the end user communication device at step 1103 indicating the latest state of the inventory, where the consumer may select and book from the available resources. If at step 1105 the system determines the resource is still available the system updates the inventory database to reflect the resource as booked, to prevent other consumers also viewing available properties from simultaneously booking that resource.

After the inventory database update step 1105, the system proceeds to step 1106 where the system enters a reservation and booking process. The reservation and booking process may include paying for, or putting a deposit down on the reservation. In the presently preferred embodiment the booking process may only be accomplished when the consumer is logged into the system. However, alternate embodiments of the present invention could allow booking without the consumer being logged into the system. In such and embodiment the reservation and booking process may include collecting information on the consumer, and the reservation and booking process may occur prior to the inventory database update step.

While the above embodiments were described in the context of web accessible pages viewed through and internet browser, alternate embodiments could use other technologies or client side agents, to provide access to the pages and functionality described in the present application.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method of displaying and booking facilities resources for a business center, comprising:
receiving a request for available facilities resources in a business center;
presenting a plurality of available business center facilities resources to an end user communication device, wherein at least two if the plurality of resources are from distinct business centers;
receiving a booking request specifying at least one business center facilities resource for booking
booking the specified business center facilities resource in response to said received request; and
updating a database to reflect the specified business center facilities resource is no longer available.

2. The method of claim 1, wherein the request for available facilities resources include at least one qualification criteria, and wherein the available business center resources presented in response to said request satisfy the at least one qualification criteria.

3. The method of claim 2, wherein the qualification criteria is a specific date.

4. The method of claim 2, wherein the qualification criteria is a range of dates.

5. The method of claim 2, wherein the qualification criteria is a geographic location.

6. The method of claim 2, wherein the qualification criteria specifies a facilities resource type.

7. The method of claim 6, wherein the facilities resource type is an office.

8. The method of claim 6, wherein the facilities resource type is a conference room.

9. The method of claim 8, wherein the qualification criteria specifies the number of persons a conference room may accomodate.

10. A method of providing available business center facilities resource information and booking in a reservation system, the reservation system having an inventory database containing facilities resource availability information, the business centers having a business center server with facilities resource availability information, comprising:
synchronizing the inventory database of the reservation system with the facilities resource availability information of at least one business center server;
presenting a plurality of available business center facilities resources to an end user communication device in response to a request for available business center facilities resources, wherein at least two if the plurality of resources are from distinct business centers;
receiving a booking request specifying at least one business center facilities resource for booking; and
updating the inventory database of the referral system to reflect the specified business center facilities resource is no longer available.

11. The method of claim 10, wherein the booking request includes a date relating to the date the business center facilities resource is available for renting.

12. The method of claim 11, wherein the business center facilities resource is an office.

13. The method of claim 11, wherein the business center facilities resource is a conference room.

14. The method of claim 13, wherein the booking request also specifies the time the conference room is available for renting.

15. A method of displaying facilities resources for a business center at a business center portal, comprising:
presenting a selection page where a visitor may enter criteria for a business center facilities resource, the entered criteria including information specifying a date;
receiving a request for available facilities resources in a business center;
retrieving at least one business center facility resource; and
presenting the retrieved at least one business center facility resource to an end user communication device.

16. The method of claim 15, wherein the specified date is a range of dates.

17. The method of claim 15, wherein the retrieved at least one business center facility resource includes two business center facility resources from different business centers.

18. The method of claim 17, wherein the business center facilities resource is a conference room.

19. The method of claim 15, wherein the availability is based upon a prior synchronization between a database of the business center portal and the database of at least one independent business center.

20. The method of claim 19, wherein the synchronization updates the database of the independent business center to reflect the bookings made at the business center portal.
